(19) United States
(12) Patent Application Publication
(10) Pub. No.: US 2023/0142578 A1
(43) Pub. Date: May 11, 2023

(54) SYSTEM AND METHOD FOR DETECTING WELDING BASED ON EDGE COMPUTING

(71) Applicant: Fulian Yuzhan Precision Technology Co.,Ltd, Shenzhen (CN)

(72) Inventors: XIONG-BO LI, Shenzhen (CN); TSUNG-JU LIN, New Taipei (TW); DAO-LIANG ZHOU, Shenzhen (CN); CHENG-LUN LEE, New Taipei (TW); CHEN-TING WU, New Taipei (TW)

(21) Appl. No.: 17/948,443

(22) Filed: Sep. 20, 2022

(30) Foreign Application Priority Data
Nov. 9, 2021 (CN) 202111321895.5

(51) Int. Cl. G06T 7/00; G06T 5/00; G06T 5/20; G06V 10/94

(52) U.S. Cl. CPC G06T 7/0004; G06T 5/002; G06T 5/20; G06V 10/95; G06T 2207/30136; G06T 2207/30164; G06T 2207/20081; G06T 2207/20032; G06T 2207/20028; G06V 2201/06

(57) ABSTRACT

A system and a method for detecting welding based on edge computing, the system includes at least one edge server, each edge server configured to obtain welding information of at least one welding machine, preprocess the welding information to generate processed data, input the processed data to a trained algorithm to generate a detecting result, and determine a welding quality of the welding machine according to the detecting result; and a data server coupled to the at least one edge server and configured to process and store the detecting result and the welding information uploaded by each edge server, generate display information, and visualizes the detecting result according to the display information.

### CROSS-REFERENCE TO RELATED APPLICATIONS

This application claims priority to Chinese Patent Application No. 202111321895.5 filed on Nov. 9, 2021 in China National Intellectual Property Administration, the contents of which are incorporated by reference herein.

### FIELD

The subject matter herein generally relates to welding detecting technology, and particularly to a system and a method for detecting welding based on edge computing.

### BACKGROUND

In the field of detecting welding of workpieces, there are many applicable methods, a first one is using traditional imaging algorithm and deep learning algorithm. However, the traditional imaging algorithm has defects like lack of robustness, and requires a high relevance of products and images; the deep learning algorithm emphasizes standards of defects to detect defects and their positions. If the defect standard changes, readjusting marks and training are needed. A second method is to conduct a destructive testing to determine a weld quality according to a result of the test. However, it may be difficult to intuitively observe the weld quality during the welding process in real time, and such destructive testings cost much time, materials, and human resources. A third method is detecting the welded workpieces by human eye, which depends on the experience of the operators to determine whether the welded workpieces are qualified, and conducting destructive testing in relation to the samples of the processed materials. However, the input from skilled operators is intensive during the analysis, which results in high labor cost; furthermore, such a method is low in automation, and therefore, is error rates in analysis may be high and efficiency low.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic diagram of at least one embodiment of a system for detecting welding based on edge computing according to the present disclosure.

FIG. 2 illustrates another schematic diagram of at least one embodiment of the system for detecting welding based on edge computing according to the present disclosure.

FIG. 3 illustrates another schematic diagram of at least one embodiment of the system for detecting welding based on edge computing according to the present disclosure.

FIG. 4 illustrates a flowchart of at least one embodiment of a method for detecting welding based on edge computing according to the present disclosure.

FIG. 5 illustrates another flowchart of at least one embodiment of the method for detecting welding based on edge computing according to the present disclosure.

FIG. 6 illustrates another flowchart of at least one embodiment of the method for detecting welding based on edge computing according to the present disclosure.

FIG. 7 illustrates another flowchart of at least one embodiment of the method for detecting welding based on edge computing according to the present disclosure.

FIG. 8 illustrates another flowchart of at least one embodiment of the method for detecting welding based on edge computing according to the present disclosure.

FIG. 9 illustrates another flowchart of at least one embodiment of the method for detecting welding based on edge computing according to the present disclosure.

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein but are not to be considered as limiting the scope of the embodiments.

Several definitions that apply throughout this disclosure will now be presented.

The term “coupled” is defined as connected, whether directly or indirectly through intervening components, and is not necessarily limited to physical connections. The term “substantially” is defined to be essentially conforming to the particular dimension, shape or other word that the term modifies, such that the component need not be exact. The term “comprising,” when utilized, means “including, but not necessarily limited to”, it specifically indicates open-ended inclusion or membership in the so-described combination, group, series, and the like.

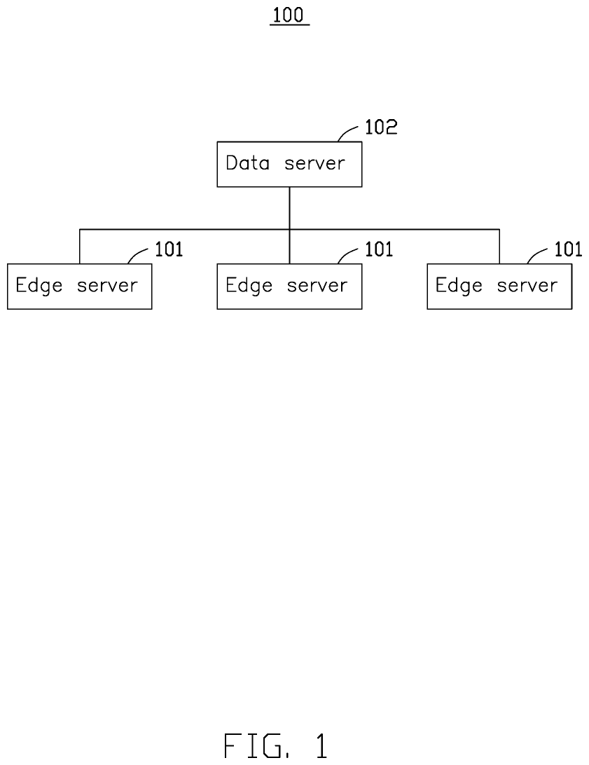

FIG. 1 illustrates a schematic diagram of at least one embodiment of a system 100 for detecting welding based on edge computing. The system 100 is configured to collect and analyze welding information of a number of welding machines in a number of dimensions, and determine a welding quality of the welding machines using welding detecting results.

Referring to FIG. 1, the system 100 includes:

At least one edge server 101, each edge server 101 is configured to receive welding information of the welding machines, preprocess the welding information to generate processed data, input the processed data to a trained algorithm to obtain a detecting result, and determine welding quality of the welding machines according to the detecting result; and

A data server 102 coupled to each edge server 101 and configured to process and store the detecting result and the welding information uploaded by each edge server 101, generate display information, and visualize the detecting result according to the display information.

Referring to FIG. 1, the system 100 includes three edge servers 101 and one data server 102. The data server 102 is coupled to the three edge servers 101 and configured to process and store the detecting results and the welding information uploaded by the three edge servers 101.

In at least one embodiment, the welding information includes at least one of welding detecting information, welding image information, and process data information. The welding detecting information includes bath of welding piece or neighborhood of the bath of the welding piece detected information during welding process, and position information of welding spots of the welding piece. The welding image information includes a first image, the first image is an image of the welding piece being welded. The process data information includes detected light information when the welding piece being welded and corresponding temperature data. The welding information may be from the number of welding machines, improving a depth and richness of the welding information.

Furthermore, when the welding information is the welding detecting information, the trained algorithm may use XGBoost model, which is not limited by the present disclosure. When the welding information is the welding image information, the trained algorithm may use semantic incision model, which is not limited by the present disclosure. When the welding information is the process data information, the trained algorithm may use K-means model, which is not limited by the present disclosure.

In at least one embodiment, when the welding information is the welding detecting information, the trained algorithm may use XGBoost model, the detecting result by the XGBoost model may include determining whether the welding spots of the welding piece are qualified (OK) or unqualified (NG). When the welding information is the welding image information, the trained algorithm may use semantic incision model, the detecting result output by the semantic incision model may include at least one of defects in positions of the welding piece and defects of the welding spots. When the welding information is the process data information, the trained algorithm may use K-means model, the detecting result output by the K-means model may include a drawing force, an impact force, a twisting force, and a shear force when the welding spot is identified.

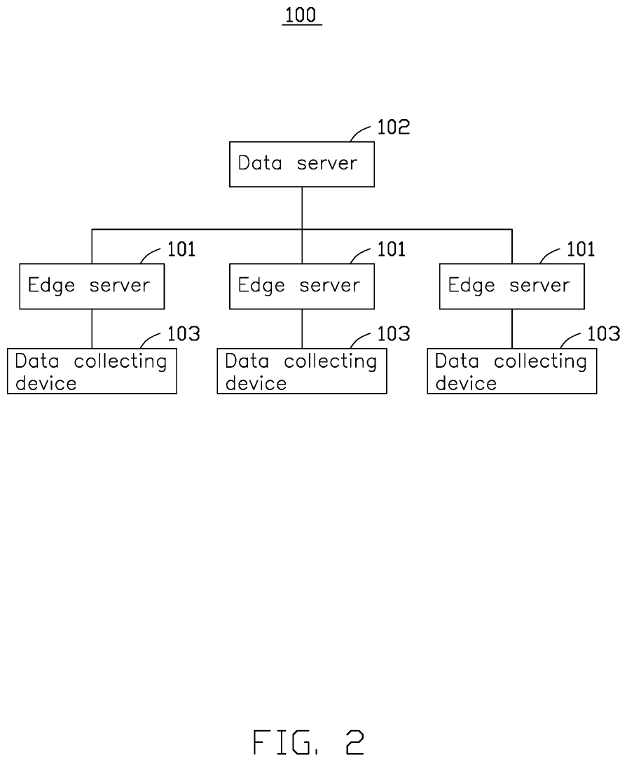

FIG. 2 illustrates another schematic diagram of at least one embodiment of the system 100 for detecting welding based on edge computing. Referring to FIG. 2, the system 100 further includes at least one data collecting device 103, each data collecting device 103 is coupled to corresponding edge server 101 and configured to collect the welding information of at least one welding machine and upload the collected welding information to the corresponding edge server 101.

Referring to FIG. 2, the system 100 includes three data collecting devices 103 respectively coupled to three edge servers 101. Each data collecting device 103 may collect the welding information of the number of welding machines and upload the collected welding information to the corresponding edge server 101. The edge servers 101 may receive the collected welding information from corresponding data collecting device 103 in real time, which decreases quantity of data delayed by being queued for transmission.

The welding information of the welding machines includes at least one of welding detecting information, welding image information, and process data information. The data collecting device 103 includes an edge gateway and a detector. The detector may include, not is not limited to, a spectrograph, an electrophotometer, an infrared camera. When the data collecting device 103 collects the welding image information during welding process, the data collecting device 103 may include, not is not limited to, a camera. When the data collecting device 103 collects the process data information during welding process, the data collecting device 103 may include, but is not limited to, the edge gateway and the detector. The edge gateway support different physical layer protocols and is configured to convert the welding information of the data collecting device 103 into information in standard format.

In at least one embodiment, the welding information includes the welding detecting information, the welding detecting information includes bath of welding piece or neighborhood of the bath of the welding piece detected information during welding process, and position information of welding spots of the welding piece, processed data includes first processed data, which is generated by preprocessing the welding detecting information, the trained algorithm includes a determining algorithm, which is formed by training historic welding detecting information. The edge server 101 further executes:

The edge server 101 obtains the welding detecting information of the welding machines. The welding detecting information bath of welding piece or neighborhood of the bath of the welding piece detected information during welding process, and position information of welding spots of the welding piece.

The welding information includes, for example, plasma neighborhood of the bath of welding piece, reflection of backlight, and temperature. The plasma, reflection of backlight, and temperature may be light emitted by the bath during the welding process, which are in a form of wave. During the detecting, the light returned during the welding process are detected. In at least one embodiment, emitted light may be divided into three kinds, ultraviolet light (UV-light), infrared light, and non-ultraviolet-and-infrared light, according to different wave lengths, which has high symbolism and is easy to differentiate between. Furthermore, the UV light is within a mechanism of plasma discharge, a physical characteristic of the ultraviolet light uses plasma, plasma being regarded as a fourth state in addition to solid, liquid, and gas states, which may indirectly reflect base situation of the bath during the welding process. A physical characteristic of the infrared light uses temperature, reflecting temperature changes during the welding process. A physical characteristic of the non-ultraviolet-and-infrared light uses the reflection of backlight, which may be reflected from concave-convex changes of welding surfaces, so as to generate the historical welding information. For instance, the plasma neighborhood of the bath of welding piece, reflection of backlight, and temperature may be obtained by analyzing the optical information and data set.

The position information of welding spots of the welding piece may be obtained by calculation according to a standard of edges of welding piece closest to the bath.

The edge server 101 further preprocesses the welding detecting information to generate the first processed data.

In at least one embodiment, the preprocess includes at least one of an average filtering, a median filtering, and a Gaussian smoothing.

The average filtering, median filtering, and Gaussian smoothing may smooth images and filter out noise, and smoothing the waves generated by the historical welding information having advantages of high smoothness and low noise. The smoothed waves with low noise form the aforesaid process information.

The average filtering, median filtering, and Gaussian smoothing are applied as a preprocess of the base waves, which preprocess may be chosen according to characteristic of the base waves. For instance, the average filtering is chosen for the base waves centering on Gaussian noise, the median filtering is chosen for the base waves centering on impulse noise.

The edge server 101 further inputs the first processed data to the determining algorithm to generate first determining information. The determining algorithm is trained by a plurality of training datasets based on the historical welding detected information through XGBoost model. For instance, the historical welding detected information includes a set of obtained bath of historically welding pieces or plasma neighborhood of the bath of the welding piece, reflection of backlight, and temperature, and position information of welding spots.

For instance, the first determining information indicates a serial generated by the determining algorithm, such as (0,1,1,1,2,1,0,0,1,1,1,1, . . . ,0,0). Therein, 0 means non-welding spot, 1 means welding spot with normal welding quality, that is process information marked as OK, 2 means welding spot with abnormal welding quality, that is process information marked as NG, adding position information and visualizing, marking the welding spot with black or other marker may directly indicate to the operator that the welding spot is NG, needs filing materials or re-checking the welding spot, and the workpiece is not allowed to enter a next process. If all welding spots are OK, the workpiece is allowed to enter the next process.

The welding characteristic and the position information are obtained during the welding process, the trained determining algorithm may output assessment of welding quality according to input welding characteristic and the position information, that is the determining information, which may be Boolean results of OK/NG, or color information marked in the welding spot positions, or specific values.

The edge server 101 further inputs the first processed data to the determining algorithm to generate second determining information.

In detail, the second determining information means serial digits generated by the determining algorithm, such as (0,1,2,1,1,1,0,0,2,1,1,1, . . . ,0,0).

The edge server 101 further, according to the first determining information and the second determining information, determines a connected area of the first determining information and the second determining information.

For instance, through comparing the first determining information and the second determining information, in a second to a sixth element of the first determining information, the fifth element is 2, and other elements are 1. In a second to sixth element of the second determining information, the third element is 2, and other elements are 1. Thus it can be determined that the second, third, fourth, and sixth elements of the first determining information and the second, fourth, fifth, and sixth elements of the second determining information cooperatively form a connected area.

Particularly, a connected area is determined by a connected component marking algorithm.

The edge server 101, to mark the connected area, further analyzes a principal component of the first determining information and the second determining information.

For instance, based on the connected area formed by the second, third, fourth, sixth elements of the first determining information and the second, fourth, fifth, sixth elements of the second determining information, there are a number of elements with a value 1. All the connected areas are determined as 1, such as (0,1,1,1,1,1,0,0,1,1,1,1, . . . ,0,0). During the welding process, the determining algorithm has a rate of precision, and if adjusting a sensitivity of the determining algorithm to stop when there is an NG (that is, the value is 2), this decreases an efficiency and increases a cycle time (CT), and the welding quality will not meet requirements. In addition, if there is welding quality issue during the welding process, there may be more than one or two values which are NG, but a series of data being NG will decrease the welding quality, so analyzing the principal component, marking the connected area combining the first determining information and the second determining information, and forming the determining result will improve efficiency and decrease errors.

In other embodiments, marking the process information with different colors, for instance green-marking an area of the process information with normal welding quality, and red-marking an area of the process information with abnormal welding quality.

According to the marked connected area, the edge server 101 further adjusts the first determining information or the second determining information, to form third determining information.

The third determining information is a series of digits formed after marking the connected area combining the first determining information and the second determining information, such as (0,1,1,1,1,1,0,0,1,1,1,1, . . . ,0,0), and adjusting the formed determining information by the connected component marking algorithm may improve a precision of the formed determining information.

In other embodiments, forming a number of information as to determinations, and further forming a final determining information based on the number of determining information.

In at least one embodiment, the display information includes first display information corresponding to the third determining information formed based on the first processed data. The data server 102 further operates:

The data server 102, according to the third determining information and the position information of the welding spots of the welding piece, generates the first display information, and further shows a determining result of the welding spots according to the first display information.

The welding piece includes at least one welding spot, such as welding spot 1, welding spot 2, and welding spot 3, at different locations. The first display information corresponds to the third determining information formed based on the first processed data, the first display information may be displayed in a display or through images, or by other way. For instance, according to the third determining information, determining that the welding spot 1 is disqualified (NG), the welding spot 2 is qualified (OK), and the welding spot 3 is disqualified (NG), and setting a display for example, through outputting and transmitting control information according to the position information, such as coordinate information, red-dot-marking of the welding spot 1 and the welding spot 3, and green-dot-marking the position of the welding spot 2. The operator may be made aware of the welding situations according to the visual information, which avoids not being able to determine same by direct observation and so reduces mis-detections, collects data of welding and forms new historical welding information, and optimizes the determining algorithm.

The welding detecting information used by the edge server 101 is formed during the welding process of the welding machine, the first determining information is formed according to the trained determining algorithm and configured to determine the quality during the welding process, thus the detecting result is closer to the actual situation, realizing the quality detected during the welding process, improving the real-time performance, reliability of data, and precision of detecting welding quality, decreasing human operation, time spent in analysis, and materials, and is good for quantitative analysis.

In at least one embodiment, the welding information further includes welding image information, the welding image information includes a first image of the welding piece being welded. The processed data further includes second processed data, the second processed data is extracted based on the first image. The trained algorithm further includes a logic process unit, the logic process unit is created by self-learning based on the historical welding image information. The edge server 101 further execute:

The edge server 101 further receives the first image of the welding machine. The first image is an image formed after the welding piece was welded. The welding piece may be at least one of screw bolt or flange.

The edge server 101, according to the first image, extracts the second processed data. The second processed data includes at least one of outline of the welding piece (such as outline of the screw bolt and/or flange), locations of welding spots (such as positions of welding spots of the screw bolt and/or flange), defective points, and centers of the welding spots. The defective points may be unfilled corners of the flange.

The edge server 101 further inputs at least one of outline of the welding piece, positions of the welding spots, defective points, and centers of the welding spots to the logic process unit, to identify welding fault spots.

The welding defects include at least one of quantities of missing or broken welds, quantities of welding spots lacking, a ratio of overwelds, a ratio of defective points, a ratio of welding through-holes, and a degree of displacement of the screw bolt.

The logic process unit is formed by self-learning according to the historic welding image information by semantic cutting model. The historic welding image information includes at least one historic welding image information marked according to historic welding defect information. Several welding defects formed by welding the welding piece are pre-collected, as are historic welding defect formed according to the several welding defects, markings of the historic welding defect to corresponding historic first image, historic welding images formed information, which is used for self-learning of the semantic cutting model.

In at least one embodiment, the display information further includes second display information corresponding to the welding defects formed based on the second processed data. The data server 102 further execute:

The data server 102, based on the welding defects, forms the second display information, and displays the visualized welding defects or characterized values of the welding defect according to the second display information.

The second display information displays the welding defects in the first image. The second display information displays quantized information of the welding defect and expresses the welding defect, which may be more easily be observed than those welding defects observable in the image by an operator. The second display information may be at least one of data, table, or image. The data and table may indicate the characteristic value of the welding defect, the image may indicate the concretization of the welding defect.

Forming the second display information of the welding defect may be at least one of defect display information of quantity of missed or broken welds, quantity of welding spots lacking, the ratio of overwelds, the ratio of defective points, the ratio of welding throughholes, and the degree of displacement, to express the welding defect according to the defect display information.

According to the first image and the second display information, the data server 102 further generates a second image.

The second image is an image marked with defects, that is the second display information is displayed in a form of images.

The data server 102 overlays the second display information to the first image. The first image overlaid with the second display information includes defect information, so the first image shows the defect information. Thus, the operator may directly observe the defect information of the second display information in the first image.

In at least one embodiment, the welding information further includes process data information, the process data information includes light and corresponding temperature data information when the welding piece is being welded. The processed data further includes third processed data. The third processed data is formed by preprocessing the process data information. The trained algorithm further includes a model for a process of quality prediction, which is obtained by training a K-means model with a plurality of historic destructive test result datasets and historic processing datasets. The edge server 101 further execute:

The edge server 101 receives the processing datasets of the welding machine, and preprocesses the processing datasets to form the third processed data.

The process data information includes light and corresponding temperature data information when the welding piece is being welded. The process data information may be from a number of welding machines for improving depth and richness of the process data information. For instance, when the welding machine welds the welding piece, the laser used by the welding machine may be infrared, UV-light, or other light with specific waveform. The laser generates temperature data information since using infrared and plasma data information since using UV-light, the data information may be process data information of materials.

In at least one embodiment, the preprocess includes at least one of average filtering, median filtering, and Gaussian smoothing.

The edge server 101 further inputs the third processed data to the processing quality prediction algorithm, and outputs predetermined result of welding quality of the welding piece. The predetermining result may include a drawing force, an impact force, a twisting force, and a shear force when the welding spot is identified.

The processing quality prediction algorithm may be training a predetermined model with a plurality of the historic destructive test result datasets and historic processing datasets. The historic destructive test result datasets may be obtained by destructive testing of welded materials. The historic destructive test result datasets may include a drawing force, an impact force, a twisting force, and a shear force when the welding spot is identified. When testing welded materials to destruction, the materials may not be recovered, each destructive testing may obtain at least one of drawing force, impact force, twisting force, and shear force.

For instance, after obtaining and using the process data predetermining model, inputting the process data information to the process data predetermining model, the process data predetermining model outputs predetermined result of process quality of materials. The predetermining result includes a drawing force, an impact force, a twisting force, and a shear force when the welding spot is identified. Thus, the edge server 101 receives process data information and destructive test result information of the welding piece, obtains processing quality prediction algorithm based on the process data information and destructive test result information, inputs the process data information to the processing quality prediction algorithm, outputs predetermined result of the process quality of materials, to provide solution of predetermining the process quality of the welding piece, so the detecting of the process quality of the welding piece depends on big data and not experience of the operator, which decreases human cost and improves automated detecting and efficiency of the process quality of the welding piece.

For instance, the testing to destruction executes casual inspection to the materials with a predetermined result of qualified, and executes complete inspection to the materials with a predetermined result of disqualified. Updating the processing quality prediction algorithm according to destructive test result information of the casual inspection and completing inspection and corresponding process data information. Thus, according to the casual inspection of the materials with a predetermined result of qualified and the completion of inspection of the materials with a predetermined result of disqualified, more testing to destruction information is obtained, which is good for improving sample quantity of destructive test result information. According to updating the processing quality prediction algorithm according to destructive test result information of the casual inspection and completion of inspection and corresponding process data information, a precision of the predetermination of the process data predetermining model is improved.

In at least one embodiment, the display information further includes third display information corresponding to predetermined result of welding quality of the welding piece formed by process data information. The data server 102 further executes:

The data server 102 generates the third display information based on the predetermined result of welding quality of the welding piece, to show welding quality of the welding piece according to the third display information.

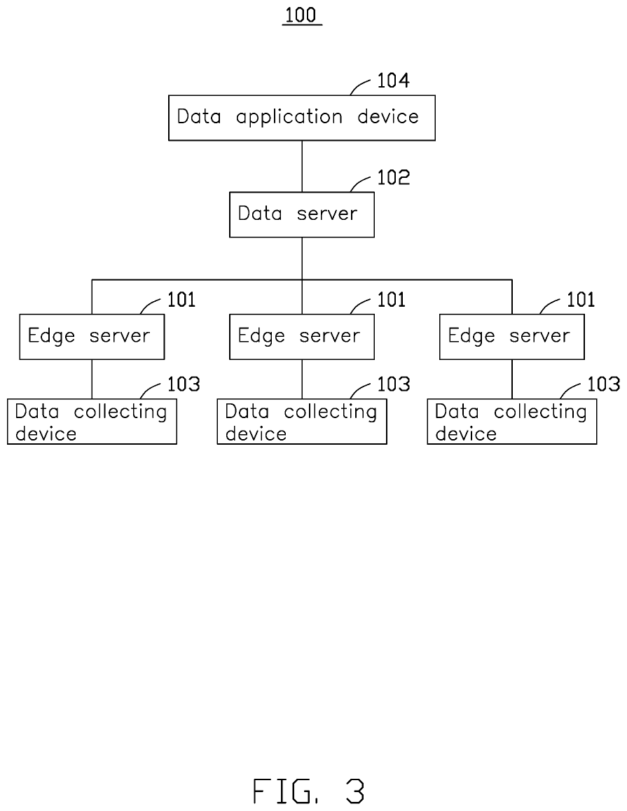

FIG. 3 illustrates another schematic diagram of at least one embodiment of the system 100 for detecting welding based on edge computing. Referring to FIG. 3, the system 100 further includes data application device 104 coupled to the data server 102. The data application device 104 is configured to receive detecting results and welding information uploaded by the data server 102; obtain destructive test result information of the welding piece including the destructive test result information about casual inspection to the materials with a predetermined result of qualified and complete inspection to the materials with a predetermined result of disqualified; based on the detecting result, the welding information, and destructive test result information, training the algorithm to obtain updated algorithm.

The data server 102 receives detecting results and welding information uploaded by three the data servers 102. The detecting result includes at least one of third determining information, welding defects, and predetermining results of welding quality. The welding information includes at least one of welding detecting information, welding image information, and process data information. Also establishing data set based on the detecting result and the welding information, and splitting the data set into welding data set and training set. The welding data set may be a set of a part of the detecting result and the welding information, the training set may be a set of another part of the detecting result and the welding information. Storing the welding data set in local database, uploading the training set to the data application device 104, the data application device 104 can timely updates the algorithm based on the training set.

In at least one embodiment, the welding information includes welding detecting information, the detecting result includes the third determining information, and the trained algorithm includes determining algorithm. The data application device 104, based on the welding detecting information and the third determining information, obtains updated determining algorithm, which may be realized by:

The data application device 104 obtains the welding detecting information, preprocesses the welding detecting information to generate the first processed data, and obtains welding characteristic of the first processed data.

For instance, the welding characteristics include at least one of maximum value, time of maximum value, average value, welding time period, and segment slope, these characteristics may be used for quantizing welding characteristic of signal welding spot, and output evaluation parameter of welding quality with specific values, such as drawing force of the welding spot through destructive testing, and may convert simulation information of base wave into digital information without value analysis and forming specific numbers, which quickens a process speed and convenient determination of welding quality during welding process, and optimizes determining logic. In detail, defining the maximum value, time of maximum value, average value, and welding time period as value characteristics, and defining the segment slope as a trend characteristic. The value characteristics may be used for simple logic determining, when some maximum criterion is exceeded, determining the welding quality is disqualified, the trend characteristic may be used for predicting trends, such as segment slope combining time nodes, determining what the probability of welding quality disqualified may be in coming moments.

The data application device 104 further generates training set according to the weld characteristic, the position information, and the third determining information, and trains the determining algorithm based on the training set, to generate new determining algorithm.

In at least one embodiment, the welding information includes welding image information, the trained algorithm includes logic process unit, the detecting result includes welding defect. The data application device 104 is configured to train the logic process unit based on the welding image information with welding defect information, to update the logic process unit, which may executed by:

The data application device 104 obtains the welding image information and welding defect information, edits the welding defect information to the welding image, to generate the welding image information with welding defect information, trains the logic process unit based on the welding image information with welding defect information, to keep updating the logic process unit and further send the updated logic process unit to the data server 102.

The data application device 104 training the logic process unit may be executed by:

The data application device 104 further sets the welding image information as training set and transmits to a convolutional layer, to generate convolution result.

In detail, transmitting the training set to the convolutional layer, the convolutional layer incises the images in the training set into a number of characteristics, to generate the convolution result.

The data application device 104 further transmits the convolution result to pooling layer, to form welding characteristics.

In detail, transmitting the convolution result to a pooling layer, which is a pyramid pooling layer, transmitting historic image incised into a number of characteristics to the convolutional layer, and recovering the number of characteristics to the historic image through the pyramid pooling layer. During a process of analyzing historic images and a number of characteristics historic image, the logic process unit obtains welding characteristic according to the training set, which may be used to identify characteristics formed by a number of welding results.

The data application device 104 further transmits the welding characteristic to a classifier, to generate a classified result.

In detail, there is one or more classifiers. There are a number of classifiers, such as a flange outline classifier, a screw bolt outline classifier, a welding spot classifier, a flange gap classifier, and a welding center classifier. Transmitting the welding characteristics to the classifier, and the classifier in classifying the welding characteristic generates a number of kinds of welding characteristics, that being the classified result.

The data application device 104 further transmits the welding defect information and the classified result to the logic process unit, to generate evaluation result.

In detail, the historic welding defect information and the classified result are transmitted to an evaluating model. In the evaluating model, setting 20% of expanded historic image as a validation set (which is not trained), 80% of expanded historic image as a training set. The training set may be trained 100 times while the validation set runs one time. During the several trainings, observing whether a function of the evaluating model is convergent, and whether a precision of the validation set improves.

The data application device 104 further determines whether the evaluation result meets a predetermined condition.

In detail, in determining whether the evaluation result meets a predetermined condition, the predetermined condition includes astringency of loss function and identifying precision of the predetermining value.

Based on the evaluation result meeting the predetermined condition, the data application device 104 further generates new logic process unit according to the logic process unit and the evaluation result.

In detail, the evaluation result meets an astringency range of loss function, and the identification of precision meets a predetermined value, and the logic process unit saves a training template for detecting welding defects of the welding piece.

In at least one embodiment, the welding information further includes process data information, the trained algorithm further includes processing quality prediction algorithm. Based on the destructive test result information and the process data information, the data application device 104 trains the processing quality prediction algorithm to generate new processing quality prediction algorithm, which may be executed by:

The data application device 104 obtains and sets a correspondence between the destructive test result information and the process data information.

For instance, for a welding piece after being welded, process data information of the welded welding piece is infrared, 2000° C., a reasonable welding spots arrangement, and the destructive test result information of the welded welding piece is drawing force of 3 kg. In setting a Correspondence, the destructive test result information and the process data information are set as infrared, 2000° C., reasonable welding spots arrangement, drawing force of 3 kg, that is, a situation of the process data information being infrared, 2000° C., reasonable welding spots arrangement, and the drawing force of the welding piece is 3 kg. Obviously, the description above is not limited by the present disclosure.

The data application device 104 further sets the destructive test result information and the process data information as training set, validation set, and detecting set. Preliminary training of the processing quality prediction algorithm is by using the training set, verifying and adjusting the preliminary trained processing quality prediction algorithm using the validation set, and detecting the adjusted processing quality prediction algorithm using the detecting set, to generate new processing quality prediction algorithm.

For instance, setting a correspondence between the destructive test result information and the process data information as training set, validation set, and detecting set is done according to a ratio of 8:1:1. Data information of elements in the training set, validation set, and detecting set are same. In other embodiments, setting a correspondence between the destructive test result information and the process data information as training set, validation set, and detecting set is done according to another ratio.

The data application device 104 further executes casual inspection to the materials with a predetermined result of qualified, and executes a complete inspection to the materials with a predetermined result of disqualified, to obtain more destructive test result information, which may increase sample quantity of the destructive test result information, updating the processing quality prediction algorithm through more destructive test result information, which may improve precision of the processing quality prediction algorithm.

The data application device 104 updates the algorithm periodically, and sends the updated algorithm to the data server 102.

The data server 102 further receives the updated algorithm including updated determining algorithm, updated logic process unit, and updated processing quality prediction algorithm, and transmits such updates to each edge server 101. Each edge server 101 is further configured to receive the updated algorithm and determine welding quality.

The system 100 for detecting welding based on edge computing may be applied in laser welding machine, which may obtain welding information of the workpiece after the workpiece is welded through the edge server 101, and may display defects of the welding, which may provide easy observation for the operator. The data application device may self-learn the defects formed during the welding, timely update the algorithm, which may be applied to different defect controlling standards. In comparison with traditional defect detecting, retraining the model is not needed for the workpiece welding defects detecting in the present disclosure, which may save human resources and improve detecting efficiency.

The system 100 for detecting welding based on edge computing may obtain process data information of the workpiece after welding through the edge server 101, and may input the process data information to the processing quality prediction algorithm, and output predetermined result of process quality of the materials, which provides solutions of predetermining the process quality of the materials, so the detecting of process quality of the materials may further depend on big data information, but not experience of the operator. Cost in labor and human resources is reduced and detecting of the process quality of the materials becomes automatic, and detecting efficiency of detecting of the process quality of the materials is improved.

The system 100 for detecting welding based on edge computing may obtain welding information during welding process through the edge server 101, generate determining information of quality during the welding process through the determining algorithm, so the detecting result is more close to actual situation, which may improve real-time performance, data reliability, and precision of detecting welding quality, decreasing human operation, analysis time, and materials, and good for quantitative analysis.

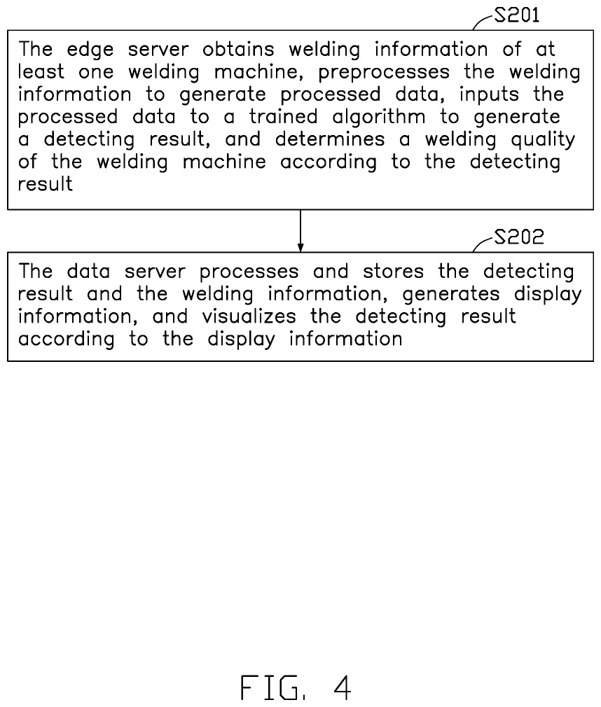

FIG. 4 illustrates a flowchart of at least one embodiment of a method for detecting welding based on edge computing. The method is provided by way of example, as there are a variety of ways to carry out the method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block S201. The method includes:

At block S201, the edge server 101 obtains welding information of at least one welding machine, preprocesses the welding information to generate processed data, inputs the processed data to a trained algorithm to generate a detecting result, and determines a welding quality of the welding machine according to the detecting result;

At block S202, the data server 102 processes and stores the detecting result and the welding information, generates display information, and visualizes the detecting result according to the display information.

The data server 102 may be coupled to a number of edge servers 101 and configured to process and store the detecting results and the welding information uploaded by the edge servers 101.

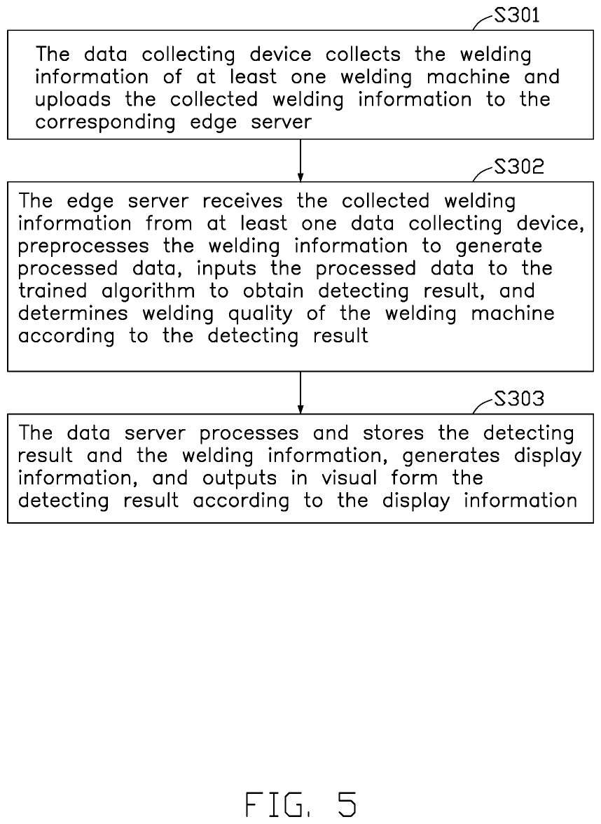

FIG. 5 illustrates another flowchart of at least one embodiment of the method for detecting welding based on edge computing. The method is provided by way of example, as there are a variety of ways to carry out the method. Each block shown in FIG. 5 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block S301. The method includes:

At block S301, the data collecting device 103 collects the welding information of at least one welding machine and uploads the collected welding information to the corresponding edge server 101;

At block S302, the edge server 101 receives the collected welding information from at least one data collecting device 103, preprocesses the welding information to generate processed data, inputs the processed data to the trained algorithm to obtain detecting result, and determines welding quality of the welding machine according to the detecting result;

At block S303, the data server 102 processes and stores the detecting result and the welding information, generates display information, and outputs in visual form the detecting result according to the display information.

Each data collecting device 103 may collect welding information of several welding machines and upload collected welding information to corresponding edge server 101. The edge server 101 directly receives the data collected by corresponding data collecting device 103 in real time, to decrease delay in queue of data in transmission.

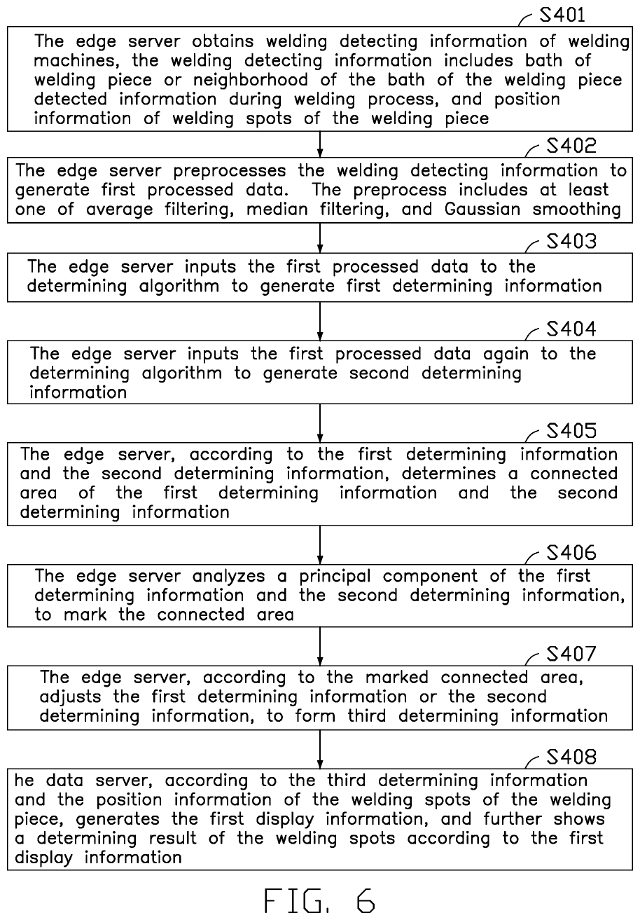

FIG. 6 illustrates another flowchart of at least one embodiment of the method for detecting welding based on edge computing. In at least one embodiment, the welding information includes welding detecting information, the welding detecting information includes a bath of welding piece or neighborhood container during welding process, and position information of welding spots of the welding piece. The processed data includes first processed data, which is generated by preprocessing the welding detecting information, the trained algorithm includes a determining algorithm, which is formed by training historic welding detecting information. The display information includes first display information corresponding to the third determining information formed based on the first processed data.

Referring to FIG. 6, the method for detecting welding based on edge computing further includes:

At block S401, the edge server 101 obtains welding detecting information of welding machines, the welding detecting information includes bath of welding piece or neighborhood of the bath of the welding piece detected information during welding process, and position information of welding spots of the welding piece;

At block S402, the edge server 101 preprocesses the welding detecting information to generate first processed data. The preprocess includes at least one of average filtering, median filtering, and Gaussian smoothing;

At block S403, the edge server 101 inputs the first processed data to the determining algorithm to generate first determining information. The determining algorithm is formed by training the historic welding detecting information through XGBoost model;

At block S404, the edge server 101 inputs the first processed data again to the determining algorithm to generate second determining information;

At block S405, the edge server 101, according to the first determining information and the second determining information, determines a connected area of the first determining information and the second determining information;

At block S406, the edge server 101 analyzes a principal component of the first determining information and the second determining information, to mark the connected area;

At block S407, the edge server 101, according to the marked connected area, adjusts the first determining information or the second determining information, to form third determining information.

At block S408, the data server 102, according to the third determining information and the position information of the welding spots of the welding piece, generates the first display information, and further shows a determining result of the welding spots according to the first display information.

The welding detecting information used by the edge server 101 is formed during the welding process of the welding machine, the first determining information is formed according to the trained determining algorithm and configured to determine quality during the welding process, thus the detecting result is close to the actual situation, realizing the quality detecting during the welding process, improving the real-time performance, reliability of data, and precision of detecting welding quality, decreasing human operation, analysis time, and materials, and is good for quantitative analysis.

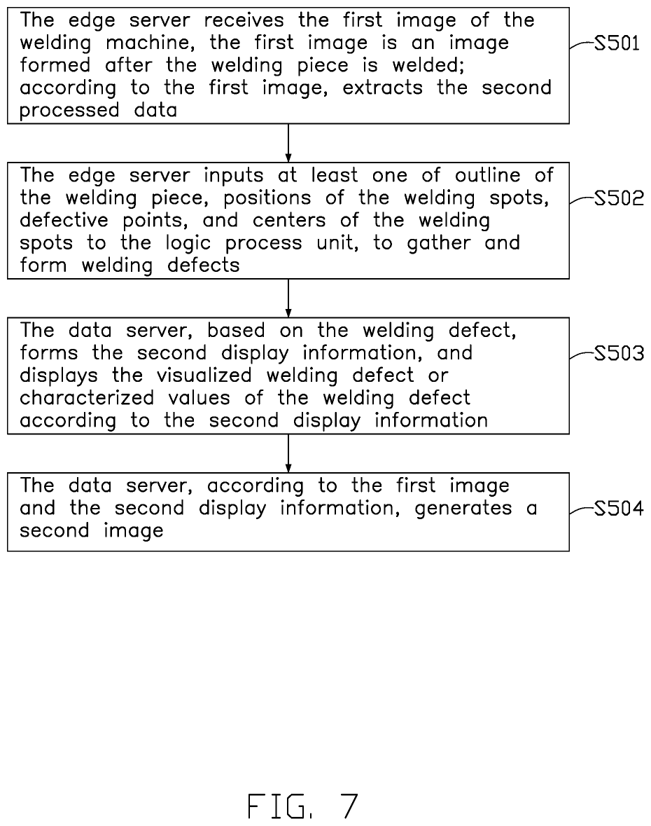

FIG. 7 illustrates another flowchart of at least one embodiment of the method for detecting welding based on edge computing. In at least one embodiment, the welding information includes welding image information, the welding image information includes a first image, the first image is an image of the welding piece being welded. The processed data further includes second processed data, the second processed data is extracted based on the first image. The trained algorithm further includes a logic process unit, the logic process unit is created by self-learning based on the historic welding image information. The display information further includes second display information corresponding to the welding defect based on the second processed data.

Referring to FIG. 7, the method for detecting welding based on edge computing further includes:

At block S501, the edge server 101 receives the first image of the welding machine, the first image is an image formed after the welding piece is welded; according to the first image, extracts the second processed data, the second processed data includes at least one of outline of the welding piece, positions of welding spots, defective points, and centers of the welding spots.

At block S502, the edge server 101 inputs at least one of outline of the welding piece, positions of the welding spots, defective points, and centers of the welding spots to the logic process unit, to gather and form welding defects.

The welding defects include at least one of quantity of missed welds, quantity of welding spots which are lacking, a ratio of overwelds, a ratio of defective points, a ratio of welding throughholes, and a degree of displacement of the screw bolt in the case of a welded flange for example.

The logic process unit is formed by self-learning according to the historic welding image information by semantic cutting model. The historic welding image information includes at least one historic welding image information marked according to historic welding defect information.

At block S503, the data server 102, based on the welding defect, forms the second display information, and displays the visualized welding defect or characterized values of the welding defect according to the second display information.

At block S504, the data server 102, according to the first image and the second display information, generates a second image.

The data server 102 shows the welding defect according to the welding display information, and the first image shows the defect information. Thus, the operator may directly observe the defect information of the second display information located in the first image.

The method for detecting welding based on edge computing may be applied in laser welding machine, which may obtain welding information of the workpiece after the workpiece is welded through the edge server 101, and may display defects of the welding, which may provide easy observation for an operator.

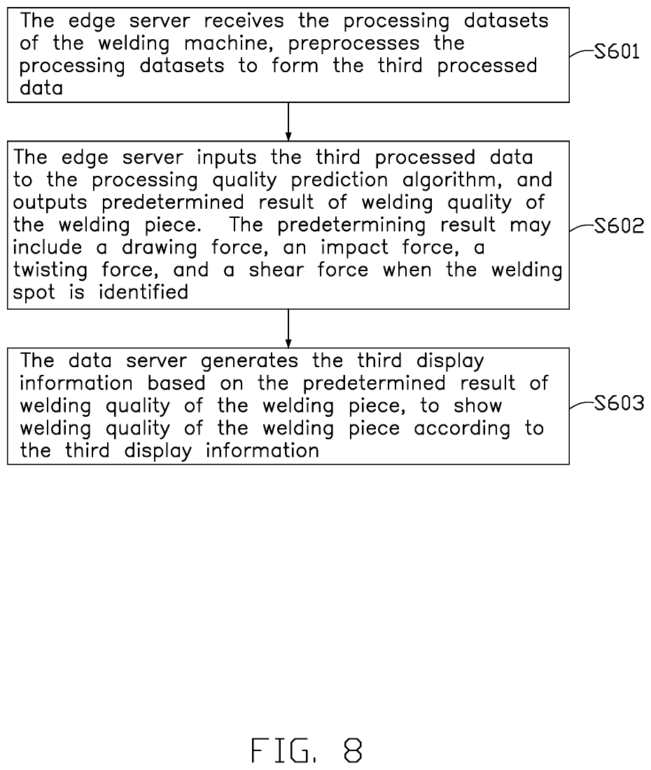

FIG. 8 illustrates another flowchart of at least one embodiment of the method for detecting welding based on edge computing. In at least one embodiment, the welding information includes process data information, the process data information includes information as to light emitted when the welding piece is welded and corresponding temperature data. The processed data further includes third processed data. The third processed data is formed by preprocessing the process data information. The trained algorithm further includes a processing quality prediction algorithm, which is obtained by training the K-means model with a plurality of historic destructive test result datasets and historic processing datasets. The display information further includes third display information corresponding to predetermined result of welding quality of the welding piece formed by process data information.

Referring to FIG. 8, the method for detecting welding based on edge computing further includes:

At block S601, the edge server 101 receives the processing datasets of the welding machine, preprocesses the processing datasets to form the third processed data, the preprocess includes at least one of average filtering, median filtering, and Gaussian smoothing;

At block S602, the edge server 101 inputs the third processed data to the processing quality prediction algorithm, and outputs predetermined result of welding quality of the welding piece. The predetermining result may include a drawing force, an impact force, a twisting force, and a shear force when the welding spot is identified. The processing quality prediction algorithm is obtained by training the K-means model with a plurality of historic destructive test result datasets and historic processing datasets.

At block S603, the data server 102 generates the third display information based on the predetermined result of welding quality of the welding piece, to show welding quality of the welding piece according to the third display information.

The method for detecting welding based on edge computing may obtain process data information of the workpiece after welding through the edge server 101, and may input the process data information to the processing quality prediction algorithm, outputting predetermined result of process quality of the materials, which provides solutions of predetermining the process quality of the materials, so the detecting of process quality of the materials may further depend on big data information and not level of experience of an operator, which decrease human labor and resources and be good for automatic detecting of the process quality of the welding piece, and improve detecting efficiency of detecting of the process quality of the welding piece.

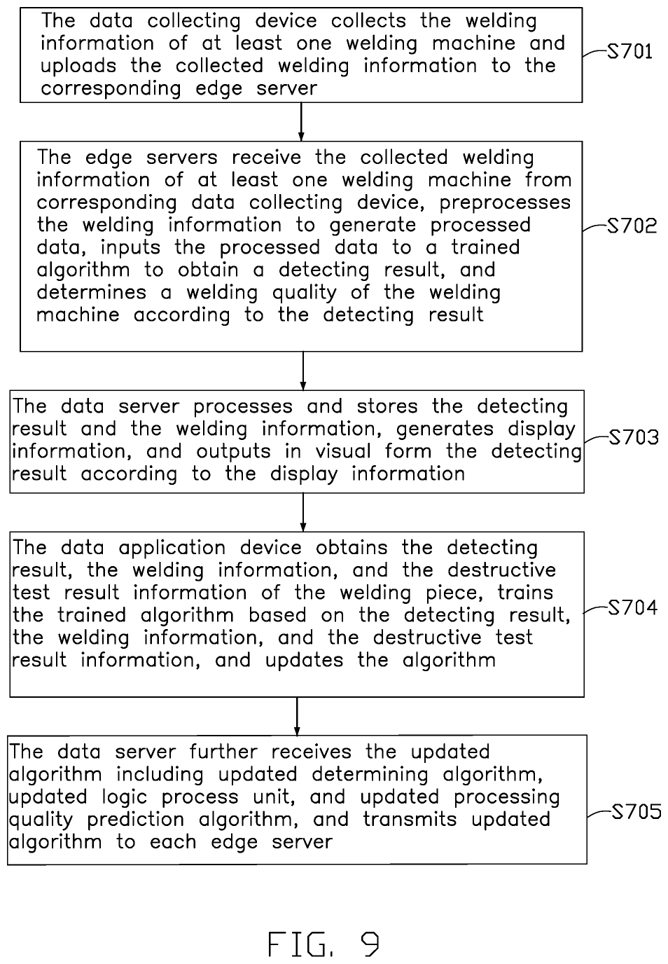

FIG. 9 illustrates another flowchart of at least one embodiment of the method for detecting welding based on edge computing. Referring to FIG. 9, the method for detecting welding based on edge computing further includes:

At block S701, the data collecting device 103 collects the welding information of at least one welding machine and uploads the collected welding information to the corresponding edge server 101;

At block S702, the edge servers 101 receive the collected welding information of at least one welding machine from corresponding data collecting device 103, preprocesses the welding information to generate processed data, inputs the processed data to a trained algorithm to obtain a detecting result, and determines a welding quality of the welding machine according to the detecting result;

At block S703, the data server 102 processes and stores the detecting result and the welding information, generates display information, and outputs in visual form the detecting result according to the display information;

At block S704, the data application device 104 obtains the detecting result, the welding information, and the destructive test result information of the welding piece, trains the trained algorithm based on the detecting result, the welding information, and the destructive test result information, and updates the algorithm;

At block S705, the data server 102 further receives the updated algorithm including updated determining algorithm, updated logic process unit, and updated processing quality prediction algorithm, and transmits updated algorithm to each edge server 101. Each edge server 101 is further configured to receive the updated algorithm and determine welding quality.

The method for detecting welding based on edge computing may be applied in laser welding machine, which may obtain welding information of the workpiece after the workpiece is welded, through the edge server 101, and may display defects of the welding, which may provide easy observation for the operator. The data application device may self-learn the defects formed during the welding, timely update the algorithm, which may be applied to different defect controlling standards. Compared to traditional defect detecting, the model does not need retraining for the workpiece welding defects detecting in the present disclosure, which may save human resources and improve detecting efficiency.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A system for detecting welding based on edge computing, the system comprising:
at least one edge server, configured to obtain welding information from at least one welding machine, preprocess the welding information to generate processed data, input the processed data to a trained algorithm to obtain a detecting result, and determine welding quality of the welding machine according to the detecting result; wherein the welding information comprises welding detecting information, the process data comprises first processed data, the first processed data is generated by preprocessing the welding detecting information, the trained algorithm comprises a determining algorithm, the determining algorithm is trained by a plurality of training datasets based on historic welding detected information;
the at least one edge server further configured to
preprocess the welding detecting information to generate the first processed data, by performing at least one of average filtering, median filtering, and Gaussian smoothing;
input the first processed data to the determining algorithm to generate first determining information;
input the first processed data again to the determining algorithm to generate second determining information;
based on the first determining information and the second determining information, determine a connected area of the first determining information and the second determining information;
analyze a principal component of the first determining information and the second determining information, to mark the connected area; and
based on the marked connected area, adjust the first determining information or the second determining information, to form third determining information;
a data server coupled to the at least one edge server and configured to process and store the detecting result and the welding information uploaded by each edge server, generate display information, and visualizes the detecting result according to the display information.

2. The system according to claim 1, wherein the welding information comprises at least one of the welding detecting information, welding image information, and process data information.

3. The system according to claim 2, wherein the welding detecting information comprises at least one of detected information of a bath of the welding piece or neighborhood of the bath of the welding piece obtained during welding and position information of welding spots of the welding piece.

4. The system according to claim 3, wherein the detected information of the bath of the welding piece or neighborhood of the bath of the welding piece is associated with light emitted by the bath during welding.

5. The system according to claim 1, further comprising at least one data collecting device, wherein each data collecting device is coupled to corresponding edge server and configured to collect the welding information of the at least one welding machine and upload the collected welding information to the corresponding edge server.

6. The system according to claim 1, wherein the display information comprises first display information corresponding to the third determining information formed based on the first processed data;
the data server is further configured to:
based on the third determining information and the position information of the welding spots of the welding piece, generate the first display information, and further display a determining result of the welding spots according to the first display information.

7. The system according to claim 1, wherein the welding information comprises welding image information, the welding image information comprises a first image, the first image is an image of the welding piece being welded; the processed data further comprises second processed data, the second processed data is extracted based on the first image; the trained algorithm further comprises a logic process unit, the logic process unit is created by self-learning based on the historic welding image information;
the edge server is further configured to:
based on the first image, extract the second processed data, the second processed data comprises at least one of outline of the welding piece, positions of welding spots, welding fault spots, and centers of the welding spots;
input the at least one of outline of the welding piece, the positions of the welding spots, the welding fault spots, and the centers of the welding spots to the logic process unit, to identify welding fault spots.

8. The system according to claim 7, wherein the display information further comprises second display information corresponding to the welding defect formed based on the second processed data;
the data server is further configured to:
based on the welding defect, form the second display information, and display the visualized welding defect or characterized values of the welding defect according to the second display information;
based on the first image and the second display information, generate a second image.

9. The system according to claim 1, wherein the welding information further comprises process data information, the process data information comprises detected light information when the welding piece being welded and corresponding temperature data; the processed data further comprises third processed data, the third processed data is formed by preprocessing the process data information, the trained algorithm further comprises a processing quality prediction algorithm, the processing quality prediction algorithm is obtained by training a predetermined model with a plurality of historic destructive test result datasets and historic processing datasets;
the edge server is further configured to:
receive the processing datasets of the welding machine, preprocess the processing datasets to form the third processed data, the preprocess comprises at least one of average filtering, median filtering, and Gaussian smoothing;
input the third processed data to the processing quality prediction algorithm, and output predetermined result of welding quality of the welding piece; the predetermined result comprises a drawing force, an impact force, a twisting force, and a shear force when the welding fault spot is identified.

10. The system according to claim 9, wherein the display information further comprises third display information corresponding to predetermined result of welding quality of the welding piece based on the process data information;
the data server is configured to:
generate the third display information based on the predetermined result of welding quality of the welding piece, to show welding quality of the welding piece according to the third display information.

11. The system according to claim 10, further comprising a data application device coupled to the data server and configured to:
receive the detecting result and the welding information uploaded by the edge server;
obtain the destructive test result information of the welding piece, the destructive test result information comprises casual inspection to the welding piece with a predetermined result of qualified and the complete inspection to the welding piece with a predetermined result of disqualified according to the processing quality prediction algorithm;
based on the detecting result, the welding information, and destructive test result information, retrain the trained algorithm to obtain an updated algorithm; and
send the updated algorithm to the data server.

12. The system according to claim 11, wherein the data server is further configured to receive the updated algorithm and transmit the updated algorithm to each edge server;
the edge server is further configured to receive the updated algorithm and determine the welding quality of the workpiece.

13. A method for detecting welding based on edge computing, the method comprising:
obtaining welding information from at least one welding machine using at least one edge server,
preprocessing the welding information to generate processed data,
inputting the processed data to a trained algorithm to obtain a detecting result, and
determining welding quality of the welding machine according to the detecting result; wherein the welding information comprises welding detecting information, the welding detecting information comprises at least one of detected information of a bath of the welding piece or neighborhood of the bath of the welding piece obtained during welding and position information of welding spots of the welding piece, the processed data comprises first processed data, the first processed data is generated by preprocessing the welding detecting information, the trained algorithm comprises a determining algorithm, the determining algorithm is trained by a plurality of training datasets based on historic welding detected information;
preprocessing the welding detecting information using the at least one edge server to generate the first processed data, by performing at least one of average filtering, median filtering, and Gaussian smoothing;
inputting the first processed data to the determining algorithm to generate first determining information;
inputting the first processed data again to the determining algorithm to generate second determining information;
based on the first determining information and the second determining information, determining a connected area of the first determining information and the second determining information;
analyzing a principal component of the first determining information and the second determining information, to mark the connected area; and
based on the marked connected area, adjusting the first determining information or the second determining information, to form third determining information;
processing and storing the detecting result and the welding information uploaded by each edge server using a data server, generating display information, and visualizing the detecting result according to the display information.

14. The method according to claim 13, further comprising:
collecting the welding information of the at least one welding machine using at least one data collecting device and uploading the collected welding information to the corresponding edge server.

15. The method according to claim 13, wherein the display information comprises first display information corresponding to the third determining information formed based on the first processed data;
the method further comprises:
based on the third determining information and the position information of the welding spots of the welding piece, generating the first display information using the data server, and further displaying a determining result of the welding spots according to the first display information.

16. The method according to claim 13, wherein the welding information comprises welding image information, the welding image information comprises a first image, the first image is an image of the welding piece being welded; the processed data further comprises second processed data, the second processed data is extracted based on the first image; the trained algorithm further comprises a logic process unit, the logic process unit is created by self-learning based on the historic welding image information;
the method further comprises:
based on the first image, extracting the second processed data using the edge server, the second processed data comprises at least one of outline of the welding piece, positions of welding spots, welding fault spots, and centers of the welding spots;
inputting the at least one of outline of the welding piece, the positions of the welding spots, the welding fault spots, and the centers of the welding spots to the logic process unit, to identify the welding fault spots.

17. The method according to claim 16, wherein the display information further comprises second display information corresponding to the welding defect formed based on the second processed data;
the method further comprises:
based on the welding defect, forming the second display information, and displaying the visualized welding defect or characterized values of the welding defect according to the second display information;
based on the first image and the second display information, generating a second image.

18. The method according to claim 13, wherein the welding information further comprises process data information, the process data information comprises detected light information when the welding piece being welded and corresponding temperature data; the processed data further comprises third processed data, the third processed data is formed by preprocessing the process data information, the trained algorithm further comprises a processing quality prediction algorithm, the processing quality prediction algorithm is obtained by training a predetermined model with a plurality of historic destructive test result datasets and historic processing datasets;
the method further comprises:
receiving the processing datasets of the welding machine, preprocessing the processing datasets to form the third processed data, the preprocess comprises at least one of average filtering, median filtering, and Gaussian smoothing;
inputting the third processed data to the processing quality prediction algorithm, and outputting predetermined result of welding quality of the welding piece; the predetermined result comprises a drawing force, an impact force, a twisting force, and a shear force when the welding fault spot is identified.

19. The method according to claim 18, wherein the display information further comprises third display information corresponding to predetermined result of welding quality of the welding piece based on the process data information;
the method further comprises:
generating the third display information based on the predetermined result of welding quality of the welding piece, to show welding quality of the welding piece according to the third display information.

20. The method according to claim 19, further comprising:
receiving the detecting result and the welding information uploaded by the edge server;
the data application device obtaining the destructive test result information of the welding piece, the destructive test result information comprises casual inspection to the welding piece with a predetermined result of qualified and the complete inspection to the welding piece with a predetermined result of disqualified according to the trained algorithm;
the data application device, based on the detecting result, the welding information, and destructive test result information, retraining the trained algorithm to obtain an updated algorithm; and sending the updated algorithm to the data server;
the data server receiving the updated algorithm and transmitting the updated algorithm to each edge server;
the edge server receiving the updated algorithm and determining the welding quality of the workpiece.
